(19) United States
(12) Patent Application Publication
(10) Pub. No.: US 2004/0192130 A1
(43) Pub. Date: Sep. 30, 2004

(54) Sheet Material with anti-slip surface

(76) Inventors: Radu Baciu, New Westminster (CA); Martin Vido, Mission (CA); Harjinder Cheema, Mission (CA)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/432,004

(22) PCT Filed: Nov. 19, 2001
(86) PCT No.: PCT/CA01/01616

(30) Foreign Application Priority Data
Nov. 17, 2000 (CA) 2326257

(51) Int. Cl. B32B 27/04

(52) U.S. Cl. 442/19; 442/1

(57) ABSTRACT

A sheet material for use as a wrapping material has surface areas with a high coefficient of friction to provide anti-slip properties to the wrapper. The sheet comprises a woven or non-woven scrim with a polymer resin coating on one side and particles protruding from the coating to provide the anti-slip properties. The particles may be polymer resin affixed to the coating by a melt bond or they may be organic or inorganic particles partly embedded in the coating. The sheet material may include additional coatings of resin and paper on the side of the scrim opposite to the particles. The sheet material is made by a method which includes depositing the particles on the resin coating while it is still in a molten state and feeding the coated scrim with particles through a nip between two rollers.

### TECHNICAL FIELD

The invention pertains to sheet materials of the type suitable for use as wrapping to protect goods during transport or storage. In particular, it pertains to a sheet material having a surface with a high coefficient of friction, a method of making such sheet material and an apparatus for carrying out such method.

### BACKGROUND

Sheet materials comprising a scrim coated with polymer are used as wrapping materials. Such materials are used, for example, as a protective wrapping for bulk lumber, steel and aluminum sheets and beams and other products that are commonly transported on open railroad cars, trucks or in ship deck containers, or that are stored outdoors. Typically, the scrim, a sheet of non-woven polymer resin fibers or woven tapes, has a polymer coating on one or both sides thereof. Such coating provides a continuous, unbroken surface that protects the wrapped goods from the environment. The surface of such sheet material is relatively smooth and has a low coefficient of friction.

For some applications, it would be useful for the sheet material to have anti-slip properties. For example, it is often desirable to be able to stack a pallet holding a bundle of goods wrapped in such sheet material on top of another such bundle of wrapped goods. Like-wise, it is often desirable for workers involved in handling such wrapped goods to be able to walk atop such bundles. In both cases, the low coefficient of friction of the surface of the sheet material poses a safety hazard. This is particularly so in snowy, wet or cold conditions where the surface may become slippery. It would be desirable for the outer surface of the wrapping material to have anti-slip properties, i.e. a high coefficient of friction, to provide better traction for workers or to facilitate stocking.

### SUMMARY OF INVENTION

It is an object of the invention to provide a sheet material suitable for use as wrapping material, having areas on one of its surfaces that have anti-slip properties.

It is a further object of the invention to provide a method of making such sheet material, and to provide an apparatus for carrying out such method.

According to one embodiment, the invention provides a sheet material, suitable for use as a protective wrapping material, comprising a scrim having a polymer resin coating, for example a polyolefin, on one or both sides. Particles of polymer resin, preferably the same kind of polymer as the coating, are affixed to areas of a surface of the coated scrim by a melt bond and protrude from the coated scrim, providing a roughened area having a high coefficient of friction. In this specification a “high” coefficient of friction means sufficiently high to provide useful anti-slip properties to the sheet material.

According to a further embodiment of the sheet material, particles of organic materials other than polymer resins, or particles of inorganic materials, are affixed to areas of the surface of a coated scrim by being pressed into the coating and protrude from the coated scrim, providing a roughened area having a high coefficient of friction.

According to a further embodiment, the invention provides a method of making the sheet material. The coating of polymer resin, in a molten state, is applied to one side of the sheet material. Particles of selected materials are applied to areas of the coated scrim immediately after application of the coating and before it hardens, affixing the particles to the coating. Where the particles are a polymer resin, a melt bond is formed between the particles and the coating.

According to a further embodiment, the invention provides an apparatus for carrying out the aforesaid method. The apparatus has a conventional feeder roller and a wind-up mechanism roller for feeding the scrim through the apparatus. The apparatus has means for applying the molten polymer to the scrim as it moves through the apparatus, means for depositing the particles of material on the coated surface immediately after application of the coating, and means for applying pressure to the sheet material immediately after deposition of the particles.

### BRIEF DESCRIPTION OF DRAWINGS

FIG. 1 is a cross-sectional view through the sheet material according to the invention;

FIG. 2 is a top plan view of the sheet material;

FIG. 3 is a schematic, perspective view of an apparatus for making the sheet material;

FIG. 4 is a cross-sectional view of a portion of the apparatus of FIG. 3;

FIG. 5 is a partly cutaway, perspective view of the polymer powder dispenser;

FIG. 6 is a cross-sectional view of a second embodiment of part of an apparatus for making the sheet material;

FIG. 7(a) is a partly cutaway, perspective view of the second embodiment of the powder dispenser;

FIG. 7(b) is a close-up view of the surface of the pick-up roller;

FIG. 8 is a cross-sectional view through an embodiment of the sheet material having a paper layer; and

FIG. 9 is a schematic elevational view of an apparatus to apply a paper layer to the sheet material.

### DETAILED DESCRIPTION OF THE PREFERRED EMBODIMENTS

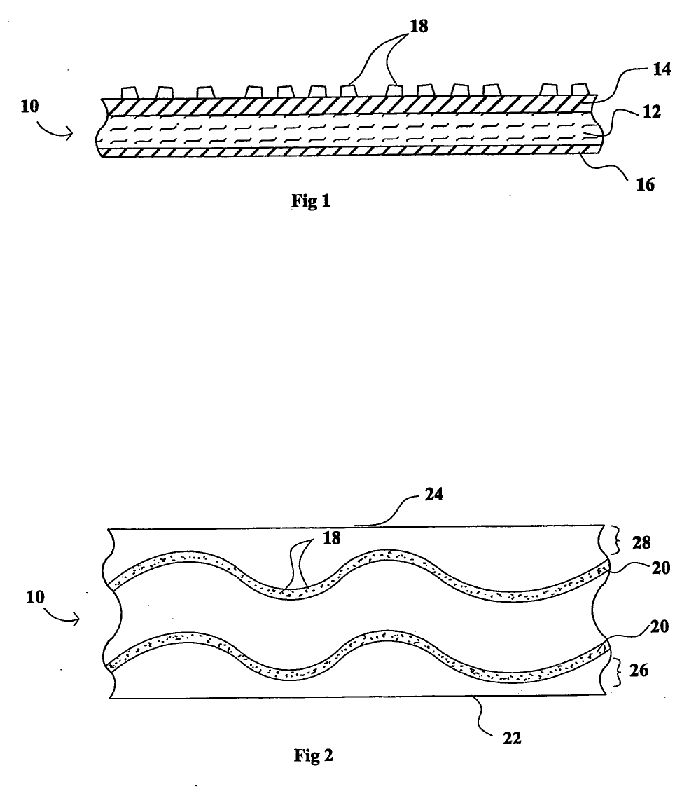

Referring to FIGS. 1 and 2, the sheet material 10 has a middle layer 12 which is a scrim preferably made of synthetic polymer resin. The scrim may be a non-woven (eg. air-laid) material, made of polymer resin fibers or a woven material, made of woven polymer resin tapes. This layer is the substrate that provides strength to the sheet material. Top layer 14 is a synthetic polymer coating, preferably a polyolefin, which forms the outer surface of the sheet material when it is used for wrapping goods. The coating 14 fills the spaces in the top surface of layer 12 and provides a continuous, substantially impermeable outer surface to the sheet material. Bottom layer 16 forms the inner surface of the sheet material 10 when it is used for wrapping goods. It is preferably a polymer resin coating.

While it is preferred that the sheet material comprise all three layers, depending on the application bottom layer 16 may be omitted, in which case the sheet material comprises layers 12 and 14. Here, the bottom side of layer 12 forms the inner surface of the sheet material when it is used for wrapping goods.

Particles 18 of a polymer resin are affixed to the upper side of layer 14 by a melt bond. A method of forming such melt bond is described below. Particles 18 impart a roughness to the outer surface of the sheet material and give it its anti-slip property.

Particles 18, middle layer 12, top layer 14 and bottom layer 16 are preferably all made of polyolefin resins, preferably polyethylene, polypropylene or a mixture thereof. Sheet 10 is completely recyclable when its entire structure comprises polyolefin resins, preferably the same one.

Resins other than polyolefins can be used for any or all of the three layers and the particles. Such resins include polyesters, polystyrene, nylon and ethylene acrylic copolymers such as ethylene metacrylic acid copolymers, ethylene vinyl acetate copolymer, ethylene methyl acrylate copolymer, and ethylene vinyl alcohol copolymer.

Particles 18 are preferably polyolefin resin particles having a mesh size in the range of 0.02-4.0 mm and more preferably 0.18-1.0 mm. In bulk, particles 18 comprise a coarse powder. Particles 18 can be made by grinding commercially available polyolefin resin pellets in conventional grinding equipment to the desired mesh size. Particles having a mesh size less than about 0.02 mm are too fine to impart adequate surface roughness to the sheet material to give it sufficient anti-slip properties. Particles having a mesh size greater than about 4.0 mm would protrude through layer 14 when it is fabricated as described below,.thus making holes in layer 14 and impairing its sealing properties.

Particles 18 can be scattered randomly across the entire surface of layer 14 or, preferably, they are placed in selected areas. Referring to FIG. 2, particles 18 are preferably located in areas 20, which form a zigzag pattern across the face of the sheet 10. When used for wrapping goods, for example a stack of lumber on a pallet, it is contemplated that areas 20 would be located on the top side of the stack, and that the areas of the sheet adjacent the side edges 22, 24, indicated generally by numbers 26, 28 in FIG. 2, would be positioned on the vertical sides of the stack. Areas 26, 28 accordingly do not require any anti-slip particles.

Areas 20 can have any desired shape. For example, they can be straight bands parallel to edges 22, 24. More or fewer than two areas 20, can be provided.

Particles 18 can be clear or colored. It is preferable for the particles to contrast in color with coating 14 in order for the anti-slip areas to be clearly visible to workers handling the wrapped goods.

It will be apparent that the sheet material can be provided with additional layers if desired for particular applications. FIG. 8 illustrates a second embodiment of the sheet material which includes a paper layer on the inner side of the material instead of an inner polymer resin layer 16. Sheet material 11 has middle layer 12 (the scrim), polymer resin coating 14 and particles 18. Paper layer 15 is bonded to middle layer 12 by a polymer resin layer 17. Layer 17 is preferably a polyolefin and, more preferably, polyethylene. Apart from the replacement of layer 16 of sheet 10 by layers 15 and 17, sheet material 11 is the same as sheet material 10.

According to a third embodiment of the sheet material, particles 18 are made from naturally-occurring organic material or from inorganic materials, ground to a mesh size of 0.02-4 mm, preferably 0.18-1.0 mm. Suitable organic materials include wood shavings and wood dust. Suitable inorganic materials include glass beads and powders, clay, calcium silicate, calcium carbonate, talc, pumice, diatomaceous earth and mica. In this embodiment, the particles 18 are affixed to the coating layer 14 but do not form a melt bond with it. Rather, particles 18 are embedded in the layer 14, by the method described below. The sheet material of this embodiment has the same layers as sheet material 10 or 11, the only difference being in the substance from which particles 18 are made and their mode of attachment of the coating layer 14.

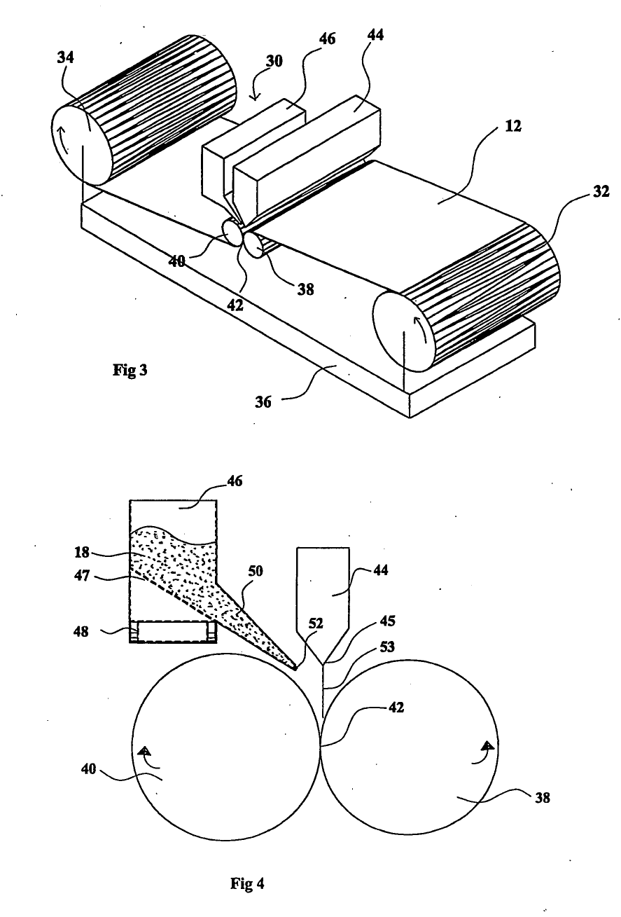

FIG. 3 is a simplified, generally schematic illustration of an apparatus for making the sheet material 10. Apparatus 30 has a feeder roller 32 and wind-up roller 34 supported on frame 36. Rubber roll 38 and chill roll 40 form a pinch point 42 therebetween. A roll of scrim 12 on feeder roller 32 is fed through pinch point 42 and onto wind-up roller 34. Extruder die 44, having a die lip 45 at its lower edge, is positioned so that the die lip is a few inches above the pinch point 42. An extruder (not shown in the drawings) supplies molten resin to extruder die 44 which extrudes a molten film 53 of polymer onto scrim 12 immediately before it passes through the pinch point.

The apparatus 30 may include a second extruder apparatus (not shown in the drawings) downstream from extruder die 44 to apply a polymer coating layer 16 to the lower side of scrim 12. Alternatively, layer 16 can be applied by means of a second pass through apparatus 30 of a roll coated on one side.

It will be understood that the apparatus 30 includes suitable drive means to turn the rollers 32, 34 and rolls 38, 40, means to adjust the position of the windup roller to maintain the required tension on the sheet, secondary rollers upstream of rubber roll 38, and means to supply resin to the extruder. The foregoing parts of the apparatus are conventional in equipment to apply polymer coatings onto substrates and are known to persons skilled in the art.

Referring to FIGS. 3, 4 and 5, in a first embodiment of the apparatus, the apparatus 30 includes powder dispenser 46 extending across the width of scrim 12 above chill roll 40. Dispenser 46 is supported by and moveable on track 48, permitting it to travel perpendicular to the direction of travel of the scrim through the apparatus. Dispenser 46 has a bin 49 with spout portion 50 (shown partly cutaway in FIG. 5 to show the interior of the bin) having openings 52 in its outer end, positioned immediately above chill roll 40 close to pinch point 42. Floor 47 of the dispenser slopes down toward openings 52 to facilitate dispensing of the powder, i.e. particles 48. Openings 52 are about 0.5 square inch in area and are adjustable to a smaller size by means of mechanical slides (not shown in the drawings) which can be locked into selected positions to change the width of the openings or to close selected openings altogether. Dispenser 46 includes an electromagnetic vibrator and associated electronic controller (not shown), which vibrates the dispenser, thus inducing the polymer powder to move through openings 52. Suitable cam means 58 and variable speed control 54 are provided to move the dispenser 46 back and forth on track 48. The speed control is electronically linked to the line speed, i.e. the speed of the web through the apparatus 30 so dispenser 46 follows the line speed to maintain the chosen traverse pattern of particles on the sheet. The extent of travel of the dispenser on tracks 48 can be set to a desired distance, preferably between about 1-6 inches, by adjusting the position of connecting rod 56 on cam 58. If desired, the bin 49 is not moved on track 48 to produce straight bands of powder on the sheet.

The sheet material 10 is manufactured on apparatus 30 according to the following method.

Scrim 12 is fed from feeder roller 32, across rubber roll 38, through pinch point 42 and onto windup roller 34, at suitable tension, forming a moving web. As the web moves, a film of molten polymer 53 is extruded from the die lip 45 of the extruder die 44 onto the scrim, immediately prior to its entering pinch point 42, forming coating layer 14. Dispenser 46 moves back and forth on tracks 48, dispensing particles 18 through openings 52 onto chill roll 40 immediately prior to the pinch point 42. The particles contact the coating layer 14 when the coating layer is still molten and the layer 14 on scrim 12 and particles 18 then move through the pinch point 42. A slight melting of the part of each particle in contact with the molten coating occurs, forming a melt bond between the particles and the coating. The melt bond, and therefore the durable attachment of the particles to the coating, is due to the heat from the molten coating layer, the immediate cooling effected by the chill roll and the pressure exerted by the rubber roll at the pinch point.

Bottom layer 16 is applied as discussed above by a second extruder die and set of chill roll and rubber roll downstream from extruder die 44, or it can be applied by means of a second, separate pass through the apparatus 30, but without the application of the polymer powder 18.

The third embodiment of the sheet material is made using the same apparatus that is described above, as dispenser 46 can dispense any of the various powders used in that embodiment. The method of making the third embodiment of the sheet material is also the same as for the first embodiment, except that the particles are not affixed to the coating by a melt bond, since the particles do not melt at the temperature of the molten polymer resin. Rather, the particles are affixed to the coating 14 by being embedded in it, as the web passes through the pinch point 42. The particles are deposited on the still-molten coating immediately before the pinch point, are pressed into it by the pressure between the chill roll and the rubber roll and are frozen in place in the coating 14 as the coating is solidified by its cooling contact with the chill roll.

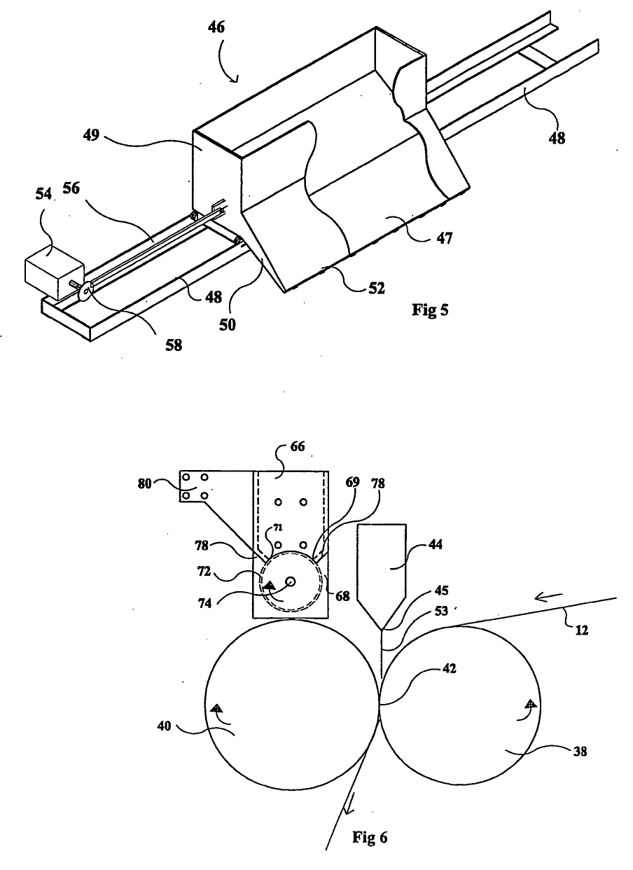

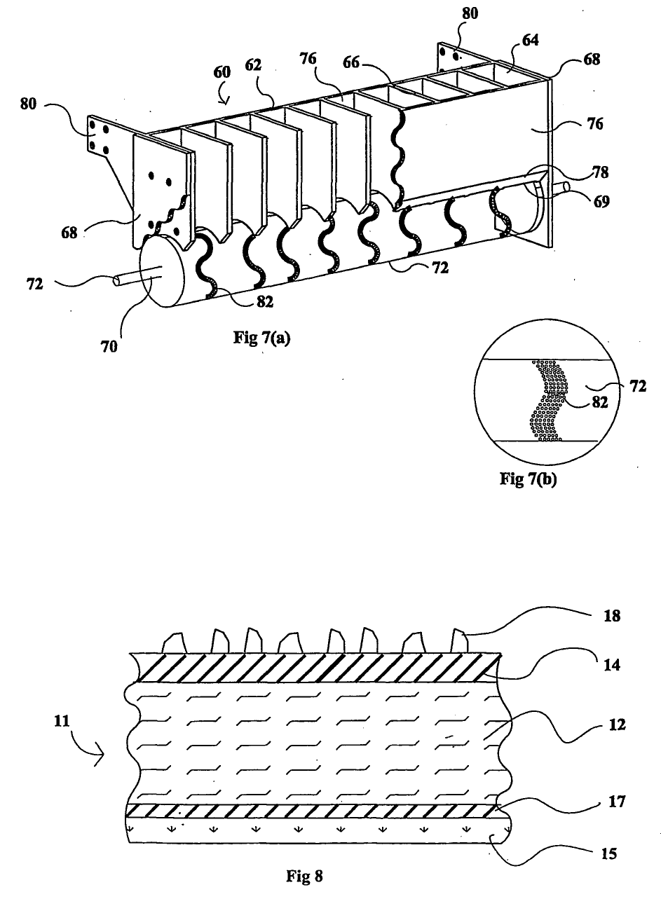

FIGS. 6 and 7 illustrate a second embodiment of the powder dispenser. Dispenser 60 is positioned above chill roll 40 and deposits powder 18 (i.e. the mass of particles 18) onto it. The chill roll, in turn, feeds the powder onto the coating 14 at pinch point 42.

Dispenser 60 comprises bin 62 which is divided a number of compartments 64, preferably ten, by means of baffles 66. Bin 62 has an end plate 68 at each end thereof with a bore 70 therein. Pick-up roll 72 is supported below bin 62 by means of its axle 74 extending through bores 70 in plates 68. Bores 70 include suitable bearings (not shown in the drawings) to permit rotation of axle 74 and pick-up roll 72.

Side walls 76 of bin 62 have a lower portion 78 which slopes downward to the pick-up roll 72 and forms a doctor seal 69, 71 therewith at their lower edges. (In FIG. 7(a), the front side wall 76, lower portion 78 and one end plate 68 are shown partly cutaway to show the internal structure of the dispenser.) Baffles 66 extend downward to the pick-up roll 72, having a clearance of about 0.025 inches therefrom. This permits free rotation of the pick-up roll 72 but prevents powder from moving from one compartment to another.

Bin 72 has a bracket 80 at each end for connection of the dispenser 60 to support members (not shown in the drawings) for holding it in place above the chill roll 40.

Pick-up roll 72 is made of chromium steel alloy. Its surface is etched with a large number of tiny pockets 82 in its circumferential surface, capable of carrying small amounts of powder 18. Pockets 82 are open at the surface of the roll. They are preferably generally concave in shape with a flat bottom. Preferably they are about 225 microns in depth, 850 microns in diameter at the top (i.e. at the surface of the pick-up roll) and 520 microns in diameter at the bottom. As pick-up roll 72 is located at the bottom of bin 62, powder 18 in the compartment 64 is in contact with it and settles into pockets 82 on the upper side of the pick-up roll. As the roll 72 rotates, in the direction indicated by the arrow in FIG. 6, the doctor seal 69 at the lower end of wall 76 removes the excess powder from the roll surface. As the roll turns further, the pockets 82 move into an inverted position, causing the powder in them to fall from the pockets onto chill roll 40. Compressed airstreams (not shown in the drawings) are directed at the roll 72 above chill roll 40 to assist in removal of powder 18 from the pockets.

Chill roll 40, rotating in the direction indicated by the arrow in FIG. 6, carries the powder deposited on it to the pinch point 42, where it is applied to the coating layer 14.

Pockets 82 are preferably etched in a pattern which traces a sinusoidal curve on roll. 72. This provides a particle deposition pattern on the sheet that is correspondingly curved, as shown in FIG. 1. For a dispenser bin 62 having compartments 64 that are about six inches long, as measured along the length of the bin, and a pick-up roll that is about 10 inches in diameter, the pattern of etched pockets is preferably about one inch wide, traversing six inches from left to right within in each bin.

If desired, the pockets 82 can be etched in an even distribution across the pick-up roll to produce an even distribution of powder on the sheet 10. They can also be etched in various other patterns, in selected densities and pocket sizes to produce various characteristics of pattern and distribution of particles 18 on the sheet.

Roll 72 is rotated by suitable drive means (not shown) engaged to axle 72. The drive means is regulated to follow the line speed so that consistent powder dispensing is provided at all line speeds.

Each compartment 64 has one corresponding band of pockets 82 on the roll 72 that receives powder only from that compartment. Since baffles 66 fit closely to the surface of roll 72, powder 18 cannot move from one compartment to another within the bin 62. This feature permits the use of less than all of the compartments, if desired, depending on the number and arrangement of powder deposition patterns wanted on a sheet 10 for a particular application. For example, only two or three compartments may be filled with powder and used to produce corresponding patterns on the sheet material.

Powder 18 is fed pneumatically into bin 62, or selected compartments thereof. Means may be provided for detecting the level of powder in the compartments and automatically adding powder when the level becomes low.

This second embodiment of the powder dispenser can also be used to dispense the non-polymer resin particles required for the third embodiment of the sheet material.

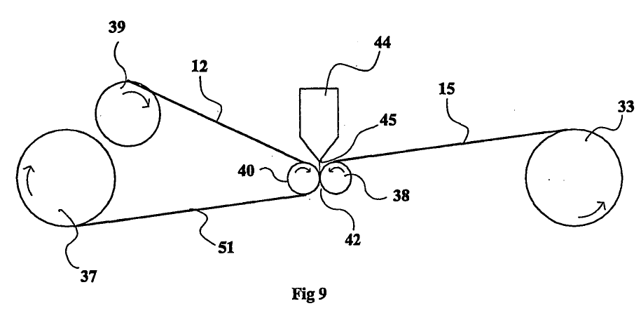

FIG. 9 is a schematic illustration of an apparatus 31 for use in making the paper-coated sheet material 11 of FIG. 8. Scrim 12 is fed into the apparatus from feeder roller 39, into pinch point 42 between chill roll 40 and rubber roll 38. Paper 15 is fed off feeder roller 33 into pinch point 42. Extruder die 44 applies a film of polymer resin, preferably polyolefin and more preferably polyethylene, between scrim 12 and paper 15 immediately before pinch point 42, bonding the paper to the scrim and forming layer 17 of the sheet material. The pressure in the pinch point is preferably about 165 lb per linear inch. Sheet 51, comprising three layers, namely scrim 12, polymer resin 17 and paper layer 15, is rolled up on windup roller 37. To complete the fabrication of sheet material 11, sheet 51 is put through apparatus 30 of FIG. 3 to apply coating 14 and particles 18, as described above.

### EXAMPLE 1

A low density polyethylene scrim 30,000 feet long and 148 inches wide is fed through the apparatus at line speeds up to 170 meters per minute. A low density polyethylene resin is melted in the barrel of the extruder at about 590° F. (310° C.) and is extruded onto the scrim at a temperature of about 570° F. (299° C.) at the die lip. The coating thickness is about 0.0008-0.004 inches and the width is up to 148 inches. The rubber roll pressure in the pinch is 125 lb per linear inch. The chill roll is water cooled and freezes the molten layer at temperatures between 60°-70° F. (15°-21° C.). The pick-up roll is 61 inches long and 10 inches in diameter. The powder dispenser (of the type shown in FIG. 5) is moved laterally along its tracks at a speed that will produce a selected zigzag pattern of polymer particles. The rate of discharge of particles is between 2 and 40 grams per square meter. Polymer powder is loaded as required into the dispenser using pneumatic transfer means.

### EXAMPLE 2

Sheet material made in accordance with Example 1 was tested for anti-slip properties. Two types of footwear were tested using a slip simulator. One was leather footwear of size 42 with a polyurethane sole without cleats. The other footwear was a rubber boot of the same size. The sheet material, prepared for use as a lumber wrap, was placed on the cooling platform of the simulator. The slip measurements were carried out on the material under both wet and dry conditions at temperatures of minus 10° C. and 0° C. The surface of the cooled sample was frosted with water vapour generated from an air humidifier. The contact angle of the footwear on the sample surface was 5 degrees. The slip resistance was assessed according to the following classification.

| Class | Assessment | Coefficient of Friction |
|---|---|---|
| 1 | Very slip-resistant | >0.30 |
| 2 | Slip-resistant | 0.20-0.29 |
| 3 | Unsure | 0.15-0.19 |
| 4 | Slippery | 0.05-0.14 |
| 5 | Very slippery | >0.05 |

Coefficients of friction for a selection of samples with different loading (light and heavy) were evaluated. Eight consecutive measurements were performed with both footwear. A control of sheet material without an anti-slip surface was similarly tested. The mean and standard deviation were calculated. Results are given in the table below.

| Coefficient of friction | |
|---|---|
| Leather footwear | Rubber footwear |

| Sample | Mean | SD | N | Mean | SD | N |
|---|---|---|---|---|---|---|
| Light, fine loading | 0.58 | 0.08 | 8 | 0.33 | 0.08 | 8 |
| Heavy, coarse coating | 0.49 | 0.06 | 8 | 0.66 | 0.07 | 8 |
| Control | 0.16 | 0.01 | 5 | 0.19 | 0.02 | 5 |

Summary of results and the slip resistance class

| | The mean coefficient of friction of two footwear | | | |
|---|---|---|---|---|
| Sample | Mean | SD | N | Class |
| Light, fine loading | 0.46 | 0.15 | 16 | 1 |
| Heavy, coarse coating | 0.58 | 0.11 | 16 | 1 |

SD, Standard deviation
N, number of tests
Class, in accordance with slip resistance classification

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A sheet-like wrapper having a surface area with a high coefficient of friction, comprising:
(a) a scrim;
(b) an extruded polymer resin coating on at least one side of said scrim; and
(c) particles of polymer resin on said area of said polymer coating, said particles being affixed to said coating by a melt bond, said particles protruding from said coated scrim.

2. A wrapper according to claim 1 wherein the mesh size of said particles of polymer resin is in the range of 0.02 to 4.0 mm.

3. A wrapper according to claim 1 wherein the mesh size of said particles of polymer resin is in the range of 0.18 to 1.0 mm.

4. A wrapper according to claim 1 wherein said polymer resin is a polyolefin.

5. A wrapper according to claim 3 wherein said scrim is polyolefin.

6. A wrapper according to claim 1 wherein said polymer resin is selected from the group consisting of polyesters, polystyrene, nylon and ethylene acrylic copolymers.

7. A wrapper according to claim 1 wherein said particles of polymer resin contrast in colour with said polymer resin coating.

8. A wrapper according to claim 1 wherein said particles of polymer resin are colorless.

9. A wrapper according to claim 1 wherein said area of said coating having said particles of polymer resin comprises a zigzag pattern area.

10. A wrapper according to claim 1 wherein said area of said coating having said particles of polymer resin comprises bands.

11. A wrapper according to claim 1 wherein said particles are scattered randomly across said surface area.

12. A wrapper according to claim 1 further comprising a second polymer resin coating on a second side of said scrim.

13. A wrapper according to claim 12 further comprising a layer of paper affixed to said second polymer resin coating.

14. A sheet-like wrapper having a surface area with a high coefficient of friction, comprising:
(a) a scrim;
(b) an extruded polymer resin coating on at least one side of said scrim; and
(c) particles of material embedded in said coating and protruding from said coated scrim.

15. A wrapper according to claim 14 wherein said particles of material are organic materials selected from the group consisting of wood shavings and wood dust.

16. A wrapper according to claim 14 wherein said particles of material are inorganic materials selected from the group consisting of glass beads and powders, clay, calcium silicate, calcium carbonate, talc, pumice, diatomaceous earth and mica.

17. A method of making a sheet-like wrapper having a surface with an area of high coefficient of friction, comprising the steps of:
(a) providing a scrim;
(b) applying a coating of polymer resin to a first side of said scrim, said coating being in a molten state upon application; and
(c) applying particles of polymer resin to an area of said coated scrim, said particles forming a melt bond to said coating, whereby said particles protrude from said coated scrim.

18. A method according to claim 17 further comprising the step of applying a coating of polymer resin to a second side of said scrim.

19. A method according to claim 17 wherein said step of applying said particles includes applying pressure to said coated scrim and particles.

20. A method according to claim 17 wherein said polymer resin is a polyolefin.

21. A method according to claim 17 wherein the mesh size of said particles is in the range of 0.02 to 4.0 mm.

22. A method according to claim 17 wherein the mesh size of said particles is in the range of 0.18 to 1.0 mm.

23. A method according to claim 17 wherein said particles of polymer resin contrast in colour with said coating of polymer resin.

24. A method of making a sheet-like wrapper having a surface with an area having a high coefficient of friction, comprising the steps of:
(a) providing a scrim;
(b) applying a coating of polymer resin to a first side of said scrim, said coating being in a molten state upon application;
(c) depositing particles of polymer resin on an area of said coated scrim, said particles forming a melt bond to said coating;
(d) feeding said coated scrim with particles through a nip between two rolls, whereby pressure is applied to said coated scrim, forming a coated scrim with said-particles protruding from said coating.

25. A method of making a sheet-like wrapper having a surface with an area having a high coefficient of friction, comprising the steps of:
(a) providing a scrim;
(b) applying a coating of polymer resin to a first side of said scrim, said coating being in a molten state upon application;
(c) depositing particles of organic or inorganic matter that do not melt in said molten coating onto said molten coating; and
(d) feeding said coated scrim with particles through a nip between two rolls, whereby pressure is applied to said coated scrim, partially embedding said particles in said coating, forming a coated scrim with said particles protruding from said coating.

26. An apparatus for making a sheet-like wrapper having a surface with an area having a high coefficient of friction, comprising:
(a) means for feeding a scrim through said apparatus, said scrim having a longitudinal dimension and a lateral dimension;
(b) means for applying a polymer resin in a molten state to an area of a first side of said scrim;
(c) means for depositing particles on an area of said coated scrim while said coating is in a molten state;
(d) means for applying pressure to said coated scrim with deposited particles; and
(e) roll-up means for rolling up said sheet material.

27. An apparatus according to claim 26 wherein said means for applying polymer resin is an extruder.

28. An apparatus according to claim 26 wherein said means for depositing particles is a dispenser having an opening from which said particles are fed onto said coated scrim.

29. An apparatus according to claim 26 where said dispenser is capable of movement relative to the lateral dimension of said scrim as said scrim moves longitudinally through said apparatus.

30. An apparatus according to claim 26 wherein said means for applying pressure is a pair of rolls having a pinch point therebetween.

31. An apparatus according to claim 26 further comprising means for applying polymer resin in a molten state to a second side of said scrim.

32. In an apparatus for applying an extruded polymer resin coating to a scrim, said apparatus having a pair of rollers with a pinch point therebetween through which said scrim passes for fixing said coating to said scrim, a dispenser for depositing a powder onto one of said rollers of said pair of rollers for application to said coating, said dispenser comprising:
(a) a bin for holding said powder;
(b) a rotatable cylindrical roll at the lower end of said bin, such that said powder in said bin is in contact with an upper part of the cylindrical surface of said roll;
(c) said roll having a plurality of pockets in the circumferential surface thereof, said pockets being capable of receiving said powder;
(d) said bin having a doctor seal against said roll which sweeps said roll as said roll rotates, removing powder from said surface of said roll while leaving powder in said pockets as said pockets are rotated past said seal and to the outside of said bin; and
(e) said pockets being capable of depositing said powder contained therein onto a roller of said pair of rollers when said pockets are in an inverted position.

33. A dispenser according to claim 32 wherein said bin has a plurality of baffles which divide said bin into compartments, said baffles having a lower end in close proximity to said circumferential surface of said roll.

34. A dispenser according to claim 33 wherein said pockets are arrayed in a plurality of circumferential bands about said roll.

35. A dispenser according to claim 34 wherein each said bands receives powder from a different compartment.

36. In an dispenser according to claim 34 wherein said bands form generally sinusoidal curves on said roll.

37. In an apparatus for applying an extruded polymer resin coating to a scrim, said apparatus having a pair of rollers with a pinch point therebetween through which said scrim passes for fixing said coating to said scrim, a dispenser for depositing a powder onto one of said rollers of said pair of rollers for application to the said coating, said dispenser comprising:
(a) a bin for holding said powder;
(b) a spout extending from said bin having a plurality of openings in a free end thereof proximate to one of said pair of rollers, whereby said powder in said bin can exit said dispenser through said openings;
(c) a track for supporting said bin and permitting said bin to move perpendicularly to the direction of movement of said scrim;
(d) means for moving said bin on said track.

38. A dispenser according to claim 37 wherein said means for moving said bin comprises a cam, a cam drive and a connector rod between said cam and said bin.
